(19) United States
(12) Patent Application Publication
(10) Pub. No.: US 2014/0356833 A1
(43) Pub. Date: Dec. 4, 2014

(54) GENERATING INFORMATION RELATING TO A COURSE OF A PROCEDURE

(71) Applicant: KONINKLIJKE PHILIPS N.V., Eindhoven (NL)

(72) Inventors: Joerg Sabczynski, Norderstedt (DE); Sebastian Peter Michael Dries, Hamburg (DE); Pavankumar Murli Dadlani Mahtani, Eindhoven (NL)

(21) Appl. No.: 14/368,627

(22) PCT Filed: Dec. 21, 2012
(86) PCT No.: PCT/IB2012/057626

§ 371 Date: Jun. 25, 2014

Related U.S. Application Data
(60) Provisional application No. 61/580,335, filed on Dec. 27, 2011.

(51) Int. Cl. G09B 5/06

(52) U.S. Cl. CPC G09B 5/06
USPC 434/262

(57) ABSTRACT

A system for generating information relating to a course of a procedure is described. A current position determiner (1) is arranged for determining a current position in a guideline (11), the current position corresponding to a status of a procedure in respect of a subject. A pathway generator (2) is arranged for generating a pathway (13) through the guideline (11), indicative of a course of the procedure. A narrative generator (3) is arranged for generating a narrative (14) describing at least part of the pathway (13) in a natural language. The narrative (14) generated by the narrative generator (3) describes an imaginary subject undergoing a similar procedure as the subject. A probability unit (4) is arranged for establishing a probability associated with an aspect of the pathway (13).

### FIELD OF THE INVENTION

The invention relates to generating information relating to a course of a procedure.

### BACKGROUND OF THE INVENTION

Patients that suffer from a particular condition or that are about to undergo a treatment may wish to be involved in the decision-making process. These patients seek information about their condition and treatment options not only from their physician, but also from other patients and/or medical literature and websites. Patient support groups offer direct contact with other patients having the same or similar diseases. The patient can benefit from the experience and coaching by others. Patient organizations provide various information adapted for non-professional readers, by means of printed booklets or through the internet. It is also possible to enable users of a web site to share information about their medical condition, their symptoms, their treatments, and their treatment outcomes. Such web sites may be used to connect members having a similar medical background.

Information on the patient is stored by hospitals or care providers in different ways. Often, electronic medical records are used to store the medical data of patients. If the hospital or care provider is part of a connected health system, its electronic medical record system may be connected to a personal health record system, which shares heterogeneous patient data across different health care systems.

In most healthcare settings, the patient does not have a direct access to the information in his or her electronic health record. Instead, this information is provided to the patient during a consultation with the treating physician. Consequently, the patient has only limited access to his or her personal clinical information. For the remainder, the patient can only obtain information from general information sources.

Individualized information is accessible to the patient only by talking to the treating physician or specialist. In many hospitals, all patient data is stored in a patient's electronic health record and the physician or specialist can read through it. Unfortunately, the time of the physician or specialist is expensive. Therefore, access to the patient's individual data is limited by the amount of time he can spend with his treating physician or specialist, since the patient's electronic health record is not meant to be accessed by the patient. It can be understood only by a medical professional.

“Critical pathways: A review”, by N. R. Every et al., Circulation 2000, 101:461-465, American Heart Association, provides a review of critical pathways in healthcare. These critical pathways are management plans that display goals for patients and provide the sequence and timing of actions necessary to achieve these goals with optimal efficiency. Although anchored in clinical guidelines, the critical pathway is a distinct tool that details processes of care and highlights inefficiencies regardless of whether there is evidence to warrant changes in those processes.

U.S. Pat. No. 6,434,531 B1 discloses a method and a system for facilitating the management of patient care by storing clinical pathway templates of pre-defined patient care paths, and assigning a template to a given patient undergoing treatment. The assigned template is tailored for the requirements of the given patient, and variances from the patient care path are collected so that the pre-defined patient care path templates can be modified with patient treatment experience.

### SUMMARY OF THE INVENTION

It would be advantageous to make available improved information relating to a course of a procedure. To better address this concern, a first aspect of the invention provides a system comprising

a current position determiner for determining a current position in a guideline, the current position corresponding to a status of a procedure in respect of a subject;

a pathway generator for generating a pathway through the guideline, indicative of a course of the procedure, based on the current position; and

a narrative generator for generating a narrative describing at least part of the pathway in a natural language.

The narrative describing at least part of the pathway provides information specific for that subject undergoing a procedure in accordance with the guideline. This allows the user to learn about his or her situation without having direct access to the status information of the subject. Such status information may be difficult to understand for a layperson, whereas the narrative description may be written in a manner that is easier to understand. Instead of generically applicable medical information about a class of diseases, the user is presented with a text in a natural language that relates specifically to a particular patient's course of the procedure. For example, the pathway may start at the current position. Alternatively, the pathway may include a historic portion representing the path followed by the patient up to the current position. The pathway may further include a future portion representing the path to be followed by the patient from the current position. The narrative generator may be arranged for generating narrative text describing at least part of either or both the historic portion and the future portion of the pathway.

The narrative generated by the narrative generator may describe an imaginary subject undergoing a similar procedure as the (real) subject. More particularly, the described imaginary subject may be considered to undergo a procedure according to the generated pathway. This enables generating a story about an imaginary subject that is tailored specifically to match the real subject. Consequently, if the real subject is a patient, the patient may recognize many details as described in the narrative during the course of the procedure. Patient stories told by real patients have the disadvantage of giving partially irrelevant and/or misleading information, distracting the patient from the most relevant information, because other patients experience different problems or events than the current patient.

The system may comprise a probability unit for establishing a probability associated with an aspect of the pathway. Such a probability may be used to take into account uncertainties associated with, for example, future pathways. Examples of aspects of the pathway may include branching points or decision points in the guideline, or different options for a particular node or edge of the guideline.

The pathway generator may be arranged for generating the pathway in dependence on the probability. In particular a portion of the pathway relating to the future may be generated in dependence on the probability. Since the generated pathway may relate to the future, it is not certain that the pathway correctly represents the pathway that the patient will follow. Consequently, probabilities may be used to select, for example, a pathway that has a sufficiently high probability of correctly representing the future course of the patient. Probabilities may also be associated with past events, for example to fill in a missing detail of a historic portion of a pathway.

The pathway generator may be arranged for generating a plurality of pathways through the guideline, wherein each pathway of the plurality of pathways represents an alternative future course of the procedure. This allows familiarizing the user with the several different possible courses that the patient may follow in the future.

The pathway generator may be arranged for generating the plurality of pathways in dependence on the probabilities associated with the potential future pathways. For example, a number of pathways may be generated that each have a sufficiently high probability to make them relevant for the patient to know about, wherein each pathway is different to cover, in the different narratives, sufficient information to teach the patient about the things the patient may encounter during the procedure.

The system may comprise a detail generator for generating additional details for inclusion in the pathway and/or the narrative. These details may be generated based on a collection of additional details associated with the different positions in the pathway. The detail generator may be used to overcome the problem that the guideline may mostly relate to information that is necessary for the clinician in making treatment decisions. The patient, however, may be interested also in other details that may be important to the patient even though they are not relevant for the treating physician when making treatment decisions. Such details may be added to the pathway and/or narrative by the detail generator. An example is a side-effect of a treatment that is inconvenient for the patient, although its occurrence does not change the treatment that is given by the physician. Moreover, these details may be added, based not only on the collection of details, but also on a random generator to account for randomness in patient pathways, to obtain a more realistic narrative of a ‘virtual patient’ undergoing a similar treatment.

The additional details may comprise effects of the condition or treatment on the patient that are not described in the guideline. This enables the patient pathway and/or the narrative to be enriched with details that are important to the patient.

The additional details in the collection of additional details may have associated therewith an indication of a probability of occurrence. This helps the pathway generator and/or the narrative generator to decide whether to include any particular detail.

The system may comprise a graphics unit for generating a graphical representation of at least part of the pathway, including the additional details. This allows the user to obtain a schematic or graphical view of the non-clinical details.

The pathway generator may be arranged for generating the pathway, based on an indication of a probability of the course of the procedure as indicated by the pathway. This allows generating only pathways that are most probably at least partly representative of the pathway of the patient.

The pathway generator may be arranged for generating the pathway, based on a clinical outcome of the course of the procedure as indicated by the pathway. For example, a number of different future pathways may be generated covering a number of different clinical outcomes. Such clinical outcomes may also relate to intermediate clinical outcomes. Such intermediate clinical outcomes may influence the course of the clinical pathway after the outcome becomes known to the clinician.

The pathway generator may be arranged for generating the pathway, based on a user selection in respect of at least part of the pathway. This allows the user to explore the anticipated pathways and to see the possible consequences of decisions that may be made along the pathway.

The pathway generator may be arranged for generating a plurality of different pathways through the guideline, wherein each pathway of the plurality of pathways is indicative of a possible course of the procedure, in particular a possible future course of the procedure, in respect of the same patient. This allows the user to obtain more comprehensive information about what the patient may experience during and/or after the treatment. The plurality of pathways may be selected, inter alia, based on the above-mentioned criteria.

The narrative generator may be arranged for generating a plurality of narratives describing the same pathway from different actors' perspectives. This allows users having different roles to be presented with narratives that are written from their own perspective. It also allows users to learn what a person having a particular role may experience. The different actors may include the patient, a healthcare worker, such as a clinician or a nurse, a relative of the patient, such as a next of kin, spouse, parent, sibling, or child of the patient.

The system may comprise a user input for enabling a user to indicate a topic. The narrative generator may be arranged for generating the narrative based on the topic indicated by the user. This allows the user to have influence on what will be described in the narrative. For example, the narrative generator may be arranged for generating a narrative that pays special attention to the indicated topic. For example, when the user is interested mostly in pain, the user may indicate the topic “pain” at the user input, and the narrative generator may generate a narrative that covers in detail the pain that may be experienced in the different stages of the pathway.

In another aspect, the invention provides a workstation comprising a system as set forth herein.

In another aspect, the invention provides a method of generating information relating to a course of a procedure, comprising

determining a current position in a guideline, the current position corresponding to a status of a procedure in respect of a subject;

generating a pathway through the guideline, indicative of a course of the procedure; and

generating a narrative describing at least part of the pathway in a natural language.

In another aspect, the invention provides a computer program product comprising instructions arranged for causing a processor system to perform the method set forth.

It will be appreciated by those skilled in the art that two or more of the above-mentioned embodiments, implementations, and/or aspects of the invention may be combined in any way deemed useful.

Modifications and variations of the workstation, the system, the method, and/or the computer program product, which correspond to the described modifications and variations of the system, can be carried out by a person skilled in the art on the basis of the present description.

### BRIEF DESCRIPTION OF THE DRAWINGS

These and other aspects of the invention are apparent from and will be elucidated hereinafter with reference to the drawings.

FIG. 1 is a block diagram of a system for generating information relating to a course of a procedure.

FIG. 2 is a flowchart of a method of generating information relating to a course of a procedure.

### DETAILED DESCRIPTION OF EMBODIMENTS

Shared Decision Making is a topic of current research in medicine. Apart from the personal consultation with his/her care provider (for example, a physician, specialist, or nurse practitioner), the patient may get information on his/her disease from information material provided by hospitals, patient organizations, or insurances. However, this material usually covers the disease in general. It is not individualized and not adapted to the patient. Therefore, potential therapies described in this material may not be suited for the individual patient. Consequently, an individual patient is presented with information about many symptoms, therapies, and side-effects, which are not relevant for him or he/she may suffer from conditions which are not covered in detail in these materials. This may lead to confusion and anxiety about taking the right decision.

In current practice, individualized information is accessible to the patient only by talking to the treating physician or specialist. In many hospitals, all patient data is stored in a patient's electronic health record and the physician or specialist can read through it. Unfortunately, the time of the physician or specialist is expensive. Therefore, access to the patient's individual data is limited by the amount of time he can spend with his treating physician or specialist, since the patient's electronic health record is not meant to be accessed by the patient. It can be understood only by a medical professional.

The techniques described herein may help to make the information in the electronic health record accessible for the patient in an intuitively understandable form. This way, the patient may access the information at any desired time, using the tools described herein. The information in the electronic health record may be automatically transformed to information that an average patient can comprehend. For example, the information may be presented by means of a description of a ‘virtual patient’.

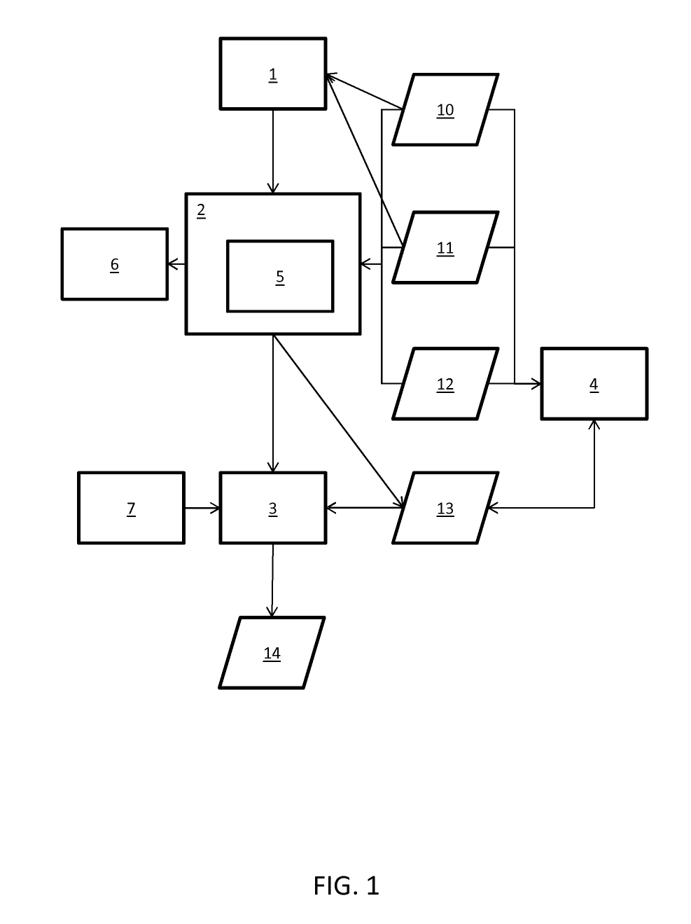

FIG. 1 illustrates, more generally, a system for generating information relating to a course of a procedure. This procedure may be a medical procedure. Other kinds of procedure may also be supported by the system. For example, the procedure can be an industrial process or a legal procedure. The system may be implemented on a computer workstation. The system may also be implemented on a distributed computation system. The system may also be implemented using dedicated electronic circuitry. The system may comprise a communications port for receiving and transmitting data, such as data indicative of a guideline, a health record, a collection of additional details, a pathway, and/or a narrative. Such data elements may alternatively be stored on a local permanent memory storage medium. The system may further comprise a loudspeaker, a display, a touch-sensitive display, a keyboard, and/or a pointing device, to provide user interaction possibilities. These elements are not shown in the drawing.

Although this description focuses on future portions of a pathway, it will be understood by the skilled person that the techniques described herein are not limited to future pathways. The same techniques may be used to generate narratives describing past pathways and/or pathways that have a historic portion and a future portion. For example, a pathway may start at a given point in the past, follow the historical path up to the current point in time, and then follow a future path, based on the guideline.

The system may comprise a current position determiner 1 arranged for determining a current position in a guideline 11. The current position determiner 1 may be arranged for accessing a data record 10 relating to the subject. For example, the system may contain a plurality of guidelines that may apply to different subjects. The data record 10 may contain information indicative of which guideline 11 is applicable. Moreover, the data record 10 may contain explicit information as to the current status and/or history of the procedure in respect of the subject, so that the current position determiner 1 can identify the current position based on this explicit information. Alternatively, this information may be extracted automatically by analyzing any information that is present in the data record 10. Data extraction techniques and techniques known in the art from the field of decision support systems may be applied for that purpose.

When the system is used in the clinical domain, the data record may be a health record, and the guideline may be a clinical guideline, and the subject may be a patient.

The system may comprise a pathway generator 2 arranged for generating a pathway 13 through the guideline 11. This pathway 13 may be indicative of a future course of the procedure. The pathway 13 may be generated, for example, by interpreting the guideline from the current position in the guideline. The pathway generator 2 may be arranged for interpreting any instructions in the guideline relating to a particular position in the guideline, to determine the next step to be performed in the procedure, which also results in a next position in the guideline. This process may be repeated until the end of the guideline has been reached, or until any other suitable stop criterion has been reached. Other stop criteria may be a predetermined number of steps that is predicted in the pathway, or a predetermined time duration covered by the pathway. The pathway may be generated such that it goes through the current position in the guideline.

The system may comprise a narrative generator 3 arranged for generating a narrative 14 describing at least part of the pathway 13 in a natural language. Natural language generation techniques may be employed to generate the narrative. Alternatively, or additionally, a collection of relevant text fragments may be used to compile the narrative. Natural language generation, or natural language production, is a subfield of the technical field of natural language processing. The structured data representation of the clinical pathway 13 generated by the clinical pathway generator 2 is transformed by the narrative generator 3 into a natural language narrative text. For example, the narrative text describes what happens in the procedure when the pathway is followed. The narrative generator 3 may be arranged for using a predetermined language style, for example a specialist language style or a layman language style. In the clinical domain, this would correspond to a medical professional language style and a patient or family member's language style. This allows the narrative to be tailored to the consumer of the narrative text 14.

The narrative 14 generated by the narrative generator 3 may describe an imaginary subject undergoing a similar procedure as the real subject for which the current position determiner 1 has identified the current position. This “similar procedure” may be a procedure according to the selected pathway. This “imaginary subject” could be regarded as a ‘virtual subject’ or a ‘virtual patient’ undergoing the same procedure (according to the selected pathway) as a real subject or patient.

The system may comprise a probability unit 4 for establishing a probability associated with an aspect of the pathway 13. The future pathway that will be followed by a subject starting from a known current position in a guideline may not be deterministically known beforehand. In this case, the pathway generator 2 is unable to determine a single unique pathway. Instead, a plurality of potential pathways could be identified. The probabilities associated with aspects of the pathway 13 help the pathway generator to make informed choices about which elements to include in a pathway and which elements to omit. Moreover, the probabilities allow the pathway generator 13 to make a selection from a potentially large set of possible pathways. Such a selection may comprise one or more potential pathways that have a given threshold probability of being followed by the subject. More generally, the pathway generator 2 may be arranged for generating the pathway 13 in dependence on the probability.

The pathway generator 2 may be arranged for generating a plurality of pathways through the guideline 11, starting at the current position, wherein each pathway of the plurality of pathways represents an alternative future course of the procedure. For example, Monte-Carlo techniques may be employed to obtain a plurality of pathways that represent the various possibilities in an evenly manner. Alternatively, simply a number of different pathways having at least a threshold number of different nodes may be generated, also taking into account the probability of occurrence of the pathways thus generated.

The system may comprise, or have access to, a collection of additional details 12 associated with different positions in the guideline 11. These additional details may hence also apply to the pathway 13, as the pathway 13 may comprise a sequence of positions in the guideline 11. The system may comprise a detail generator 5 for generating additional details for inclusion in the pathway and/or the narrative, based on this collection of additional details.

The additional details may be indicative of an effect of the condition or treatment on the patient that is not described in the guideline. These details may not be present in the guideline, because these details may not be necessary for a proper execution of the guideline. These details may be relevant for the user to know. Consequently, they may be represented by a collection of additional details. The relevant ones of these additional details may be included into the clinical pathway 13 by the pathway generator 2. The narrative generator 3 may be arranged for including narrative text relating to the relevant additional details in the narrative 14. In an alternative embodiment, the additional details are retrieved by the narrative generator 3 directly from the collection of additional details 12.

The additional details in the collection of additional details 12 have associated therewith an indication of a probability of occurrence. The pathway generator 2 and/or the narrative generator 3 may be arranged for deciding whether or not to include the additional details, based on the probability of occurrence. Moreover, the narrative generator 3 may be arranged to devote more or less natural language text to the details, based on the probability or frequency of occurrence of these details. Additional details may relate to, for example, side-effects or common anxieties of patients in the procedure.

The pathway generator 2, in the case of a non-deterministic future course of the procedure, may be arranged for making choices to select one or more particularly interesting potential pathways from among all theoretically possible pathways.

A selection of a pathway may be based on an indication of a probability of the future course indicated by the pathway 13; this indication represents how probable it is that the pathway accurately represents the future course of the procedure. This indication may be determined in many different ways. The probability may also relate to the probability that the future course of action will be sufficiently similar to the pathway.

Alternatively or additionally, a selection of a pathway may be based on a clinical outcome of the future course indicated by the pathway 13. Such a clinical outcome may be an intermediate clinical outcome (somewhere during the procedure/guideline) or a final clinical outcome (where the procedure/guideline ends). For example, an extreme outcome is selected, such as a “best-case” or a “worst-case” scenario. The clinical outcome may also relate to any one of the “additional details” described above.

Alternatively or additionally, a selection of a pathway may be based on a user selection in respect of at least part of the pathway 13. This allows the pathway and/or the narrative to be interactively modified. The user may explore the effect of decisions made to perform certain actions. For example, the effect of a particular decision to perform a particular treatment may be explored by a layman user by selecting different pathways and reading the resulting narrative.

The pathway generator 2 may be arranged for generating a plurality of pathways through the guideline. These pathways may be selected based on criteria described above. The different pathways may be selected to provide a representative overview of the most important issues a subject may experience during (or even after) the procedure. Each pathway of the plurality of pathways is indicative of a possible future course of the procedure in respect of the same subject.

The system may comprise a graphics unit 6 for generating a graphical representation of at least part of the pathway 13, including the additional details. Such graphical representation may provide additional valuable insight in temporal variations. This may also be applied to the additional details; for example, mood swings can be visualized using randomly varying mood indicators. The narrative generator 3 may be arranged for generating a plurality of narratives describing the same pathway 13 from different actors' perspectives. This allows multiple actors to be prepared for their role. Moreover, it helps different actors to imagine themselves in the position of another actor.

The system may comprise a user input 7 for enabling a user to indicate a topic. For example, the user may be enabled to select a topic from a list, or to enter a topic using free text. The narrative generator 3 may be arranged for generating the narrative, based on the topic. For example, the narrative generator 3 may be arranged to generate a narrative 14 that pays special attention to the requested topic, or to delete any information relating to the indicated topic from the narrative.

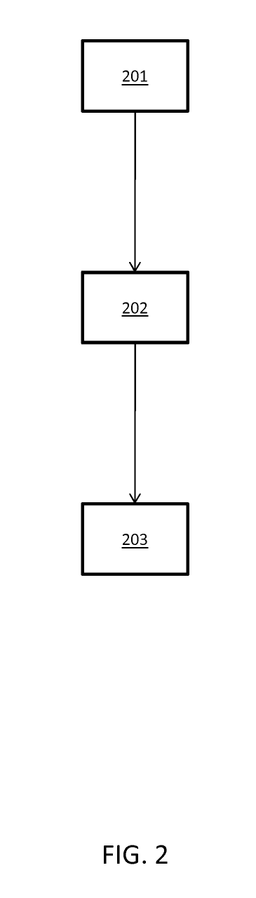

FIG. 2 illustrates a method of generating information relating to a future course of a procedure. The method comprises a step 201 of determining a current position in a guideline, the current position corresponding to a status of a procedure in respect of a subject. The next step in the method is step 202 of generating a pathway through the guideline, indicative of a future course of the procedure. The next step of the method is step 203 of generating a narrative describing at least part of the pathway in a natural language. It will be apparent that the method may be extended or modified based on the description of the functionalities of the system. Both the method and the system may be implemented at least partly as a computer program product. Moreover, they may be implemented using dedicated electronic circuitry.

Many hospitals, in particular comprehensive cancer centers, have implemented hospital-specific guidelines for the diagnosis and treatment of patients. These guidelines are based on the guidelines of specialist associations. They may contain diagnostic procedures, decision points, therapeutic procedures, potential side effects, and outcomes. In many cases, the guidelines may be represented by means of a flowchart and/or in textbook form. A formal representation, such as an electronic representation of the objects and connections of a flowchart, may be available using techniques known in the art per se.

Using such a formal representation, the current status of the diagnostic and therapeutic procedure of a patient can be marked as a position in one of the branches of the flowchart. From the guideline, information can be extracted about the future procedure the patient should undergo, and about the decisions that need to be made now or in the future, as well as about the possible treatment outcome, in dependence on the decisions that are made. Herein, predictions may be made, taking into account that patients may react differently to the same kind of treatment. Consequently, it is possible to predict treatment outcome with a certain likelihood or probability.

During the treatment, the patient's current status moves along the branches of the flowchart representing the guideline. At decision points, the path of the patient through the guideline may depend on (future) examinations of the patient and on the outcome of therapies.

The course of diagnostic and therapeutic procedures of a patient can be visualized by a pathway along the branches of the flowchart. This way, the patient's history can be shown as a clinical path showing the procedure that was followed up to this time, including the decisions made. It is also possible to show potential future clinical paths that the patient may follow as paths through the guideline. For example, such a clinical path may be highlighted in a flowchart representation of the guideline.

Scientific evidence underlying clinical guidelines allows attributing an occurrence probability to a possible pathway. It also allows attributing occurrence probabilities to possible side effects of diagnostic or therapeutic procedures associated with these pathways, and criticality of adherence to particular therapy regimens.

The system may determine the current position of the patient in the guideline/flowchart. This can be done manually by the responsible physician or automatically if the healthcare organization/hospital/insurance uses a guideline-based workflow management tool.

The system may generate a list of potential future pathways of the patient. For example, the system may generate around 10 different future pathways. This may also depend on the amount of uncertainty of the future events. The list may be populated taking into account any probabilities associated with the decision points, in particular when a decision is dependent on a future intermediate outcome of the procedure. Each pathway on the list represents a virtual (i.e. fictitious) patient history, which starts at the current position of the patient in the flowchart. If necessary, additional pathways representing extremes of the potential future development can be added (e.g. extremely good response to therapy or extremely bad response).

The selected virtual patient histories may follow the main course of the selected clinical path. Details of the virtual patient history may be generated randomly, taking into account the probabilities that these details will apply to the patient. This may be evaluated by comparing the available evidence (e.g. from clinical studies, guidelines, or drug information) with symptoms, side-effects, mood status, physical condition, etc.

The virtual patient story may also be an interactive story, including elements where the real patient interacts with the virtual patient. In this case, for example, the virtual patient may enter into a dialogue with the real patient to resolve ambiguities, or explore different treatment options and/or different branches of a clinical path.

For example, a real patient could be presented with different treatment options corresponding to different ones of a plurality of pathways through the guideline. He could then have a dialogue with different virtual patients, each of whom chose a different one of these treatment options, to better assess the impact of each available option, including, for example, associated side effects. The information gathered during this interaction may be shared with the care professional (treating physician, nurse, etc.) for use during follow-up consultations with the patient. Optionally, the patient can express his preference for one of the possible pathways, making these follow-up consultations more efficient.

A graphical representation of a virtual patient history can be created. Such a graphical representation can, for example, indicate the mood status, pain experienced, insomnia, or any other side effects or details, as a function of time.

Alternatively, or additionally, the graphical representation may include visual elements such as photographs of situations, rooms, devices and so forth, or photographs of the virtual patient (actor). For each generated virtual patient history, or future pathway including optionally additional details, a virtual patient story, or narrative, may be created. This is a representation of the virtual patient history as a storytelling text that uses language that is familiar to the average patient. The system may use a natural language generation method. If necessary, a database with text fragments for potential events can be a source for the virtual patient story elements. The text may be arranged to take into account the ‘virtual personality’ of the ‘virtual patient’ and may be created in a corresponding style.

The graphical representation may also include predefined cartoons or images retrievable from a database to support the textual virtual patient story. In this example, a the database would contain sets of predefined cartoons or images representing all possible scenarios of a patient or class of patients.

As a result, the real patient can browse through several generated ‘virtual’ patient stories, each describing a potential further development of a ‘virtual patient’, who has the same current status as the real patient, in a vivid and graphical manner. Text-to-speech technology may be used to render an auditive version of the narrative, which may advantageously be played back for accompanying a virtual patient story comprising one or more graphical representations

The virtual patient story may be written from the perspective of different persons, e.g. from the perspective of the patient, the treating clinician, a family member, or an objective narrator. A mixture of different perspectives is also possible.

The degree as to how well the system was able to generate one or more ‘virtual patient pathways’ from the available information may be calculated and provided to the user, to emphasize the fictitious character of the story. The calculation may be performed based on evidence in respect of conditions that match as much as possible history items and preferences of the real patient.

Patients may be enabled to tailor or focus the story to a particular subject. For example, they may be interested only in stories about medications: so the story will tell only medication aspects along the care cycle. Alternatively, the patient wants to focus on hospital visits and medical contacts. In this case, the story will describe these clinical contacts. Other focuses could be on education or side effects along the care cycle. Thus, the user may be enabled to filter the story down to a particular topic. The system can be implemented in such a way that the filtering of the story appears to be done interactively, e.g. in the form of a conversation or a chat.

The narrative generator may comprise a natural language generator and/or a plurality of text fragments associated with potential events, used to compile a narrative that appears to be a text written by a real human author.

The system may comprise a closeness calculating unit for calculating a measure of the degree to which the pathway matches a situation of the subject, taking into account a preference of the subject.

The techniques disclosed herein can be used as a tool for evidence-based shared decision making by cancer patients, but also by patients with other acute or chronic diseases. It can be an add-on to a clinical decision support system, but also a stand-alone product to enhance decision support for patients. The system could be built on top of decision support databases that are used by patient information services for their staff to manage, e.g., remote patient consultation.

It will be appreciated that the invention also applies to computer programs, particularly computer programs on or in a carrier, adapted to put the invention into practice. The program may be in the form of a source code, an object code, a code intermediate source and object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a flash drive or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or to be used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for generating information relating to a course of a procedure, comprising
a current position determiner for determining a current position in a guideline, the current position corresponding to a status of a procedure in respect of a subject;
a pathway generator for generating a pathway through the guideline, indicative of a course of the procedure, based on the current position;
a narrative generator for generating a narrative describing at least part of the pathway in a natural language; and
a detail generator for generating additional details for inclusion in the pathway and/or the narrative, based on a collection of additional details associated with the different positions in the pathway;
wherein an additional detail of the collection of additional details is indicative of an effect of the condition or treatment on the patient that is not described in the guideline, and wherein an additional detail of the collection of additional details has associated therewith an indication of a probability of occurrence.

2. The system according to claim 1, wherein the narrative generated by the narrative generator describes an imaginary subject undergoing a similar procedure as the subject.

3. The system according to claim 1, further comprising a probability unit for establishing a probability associated with an aspect of the pathway.

4. The system according to claim 3, wherein the pathway generator is arranged for generating the pathway in dependence on the probability.

5. The system according to claim 1, wherein the pathway generator is arranged for generating a plurality of pathways through the guideline, based on the current position, wherein each pathway of the plurality of pathways represents an alternative future course of the procedure.

6. (canceled)

7. (canceled)

8. The system according to claim 6, further comprising a graphics unit for generating a graphical representation of at least part of the pathway, including the additional details.

9. The system according to claim 1, wherein the pathway generator is arranged for generating the pathway based on at least one of:
an indication of a probability of the course of the procedure as indicated by the pathway;
a clinical outcome of the course of the procedure as indicated by the pathway; and
a user selection in respect of at least part of the pathway.

10. The system according to claim 1, wherein the pathway generator is arranged for generating a plurality of different pathways through the guideline, wherein each pathway of the plurality of pathways is indicative of a possible course of the procedure in respect of the same patient.

11. The system according to claim 1, wherein the narrative generator is arranged for generating a plurality of narratives describing the same pathway from different actors' perspectives.

12. The system according to claim 1,
comprising a user input for enabling a user to indicate a topic; and
wherein the narrative generator is arranged for generating the narrative based on the topic.

13. A workstation comprising a system according to claim 1.

14. A method of generating information relating to a course of a procedure, comprising
determining a current position in a guideline, the current position corresponding to a status of a procedure in respect of a subject;
generating a pathway through the guideline, indicative of a course of the procedure, and based on the current position; and
generating a narrative describing at least part of the pathway in a natural language;
wherein additional details for inclusion in the pathway and/or the narrative are generated, based on a collection of additional details associated with the different positions in the pathway, wherein an additional detail of the collection of additional details is indicative of an effect of the condition or treatment on the patient that is not described in the guideline, and wherein an additional detail of the collection of additional details has associated therewith an indication of a probability of occurrence.

15. A computer program product comprising instructions arranged for causing a processor system to perform the method according to claim 14.
